(19) United States
(12) Patent Application Publication
(10) Pub. No.: US 2021/0115215 A1
(43) Pub. Date: Apr. 22, 2021

(54) Method for Recycling Epoxy-Fiber Composites into Polyolefins

(71) Applicant: Dow Global Technologies LLC, Midland, MI (US)

(72) Inventor: Parvinder Walia, Midland, MI (US)

(21) Appl. No.: 17/051,851

(22) PCT Filed: May 30, 2019
(86) PCT No.: PCT/US2019/034652

§ 371 Date: Oct. 30, 2020

Related U.S. Application Data
(60) Provisional application No. 62/680,890, filed on Jun. 5, 2018.

(51) Int. Cl. C08J 11/06; C08L 23/12

(52) U.S. Cl. CPC C08J 11/06; C08J 2323/12; C08L 23/12

(57) ABSTRACT

Fiber-reinforced thermoset composites are recycled by forming them into a particulate and combining the particles with a polyolefin to produce a reinforced polyolefin. A functionalized polyolefin is present in the reinforced material. The presence of the functionalized polyolefin leads to a significant increase in the reinforcing efficacy of the thermoset composite particles.

This invention relates to a method for recycling epoxy-fiber composites into polyolefins.

Fiber-reinforced epoxy composites are finding more and more uses, mainly in transportation applications where their light weights relative to metals provides significant advantages. These composites include fiber reinforcement and a continuous resin phase that envelops the fibers and bonds them together into the desired geometry. The resin phase is a cured thermoset resin such as an epoxy, vinyl ester or polyurethane.

Some scrap and defective parts are produced as these composites are manufactured. In addition, composite parts can become broken or worn during service or may otherwise reach the end of their useful service life. In each of these cases, waste material is produced that needs to be disposed of in some manner. It would be advantageous to recycle this waste, or at least some components thereof, rather than simply disposing of it in a landfill or otherwise.

Recycling is complicated because of the highly crosslinked, thermoset nature of the cured resin phase. The material cannot be remelted and reprocessed in the same manner as virgin material.

There have been attempts to recover the fiber value from composite wastes. The fibers are often the highest-value component of the composite, especially when the fibers are expensive types such as carbon fibers. Fibers can be recovered, for example, by chemically or thermally depolymerizing or degrading the resin phase, thereby converting it to liquid and/or gaseous decomposition products that are easily separated from the fibers. This allows the fibers to be re-used. These approaches have met with significant problems. Pyrolysis requires temperatures of 500° C. or more, making the process highly energy-intensive. Carbon fibers obtained in this way retain oxidation residue or char.

Depolymerization technologies often cannot be used when the composites contain contaminants such as metals and paint, which unfortunately are usually present in all composite structures. Chemical and thermochemical processes tend to require high temperatures and/or the use of harsh chemicals.

Even when usable fibers are recovered, there remains the problem of disposing of the resin phase. The degradation products from the foregoing processes have little or no utility beyond their fuel value, and are consequently either burned or disposed of. Ultimately, only the fiber content is recycled using these fiber-recovery processes. This can be as little as 20% of the weight of the scrap material.

In principal, the entire mass of the scrap material can be recycled by grinding it into a powder and incorporating that powder into a thermoplastic resin as a filler. This avoids expensive fiber-recovery operations. The powder can substitute for mineral fillers as are commonly used with those thermoplastic resins, even offering the advantage of reduced weight relative to the mineral types. In addition, this allows for in-plant recycling capability and extraction of value from the scrap material.

Unfortunately, these powders have been found to be inefficient fillers, particularly when used to fill certain high-volume polyolefins such as polypropylene.

It would be desirable to provide a manner in which fiber-reinforced thermoset composites can be recycled into polyolefins such as polypropylene.

This invention is in one aspect a filled polyolefin comprising:

a) 30 to 90% by weight, based on the total weight of components a)-c), of an unfunctionalized thermoplastic polyolefin resin, the unfunctionalized thermoplastic polyolefin resin having dispersed therein;

b) 10 to 60% by weight, based on the total weight of components a)-c), of a particulate fiber-reinforced thermoset composite, the particulate having a maximum particle size of 10 mm; and

c) 1 to 50% by weight, based on the total weight of components a)-c), of a functionalized thermoplastic polyolefin,

wherein component b) is dispersed in component a) and component c) is dispersed or dissolved in component a).

This invention permits as much as 100% by weight of the fiber-reinforced thermoset composite to be recycled, to produce a composite having very desirable mechanical properties. It has been found, unlike the case in previous attempts to use ground thermoset composites as fillers for polyolefins, that the filled polyolefin of the invention often exhibits large and unexpected increases in tensile strength and elastic modulus, compared to the case in which the functionalized thermoplastic polyolefin is absent. In other cases, toughness and/or impact strength is increased while maintaining or even increasing tensile strength and modulus. The presence of the functionalized thermoplastic polyolefin enables the fiber-reinforced thermoset composite particles to perform as efficient fillers.

The invention is also a method for recycling a fiber-reinforced epoxy composite, comprising the steps of:

I. forming the fiber-reinforced thermoset composite into particles having a particle size of at most 10 mm;

II. combining the particles from step I with a heat-softened unfunctionalized thermoplastic polyolefin resin and a functionalized thermoplastic polyolefin resin at a weight ratio of 30 to 90% by weight of the unfunctionalized thermoplastic polyolefin resin, 10 to 60% by weight of the particles; and 1 to 50% by weight of the functionalized thermoplastic polyolefin resin, to form a filled polyolefin resin comprising the heat-softened unfunctionalized thermoplastic polyolefin resin having the particles dispersed therein and the functionalized thermoplastic polyolefin resin dispersed or dissolved therein; and

III. cooling the filled polyolefin resin from step II to solidify the filled polyolefin resin.

The invention is also a method for reinforcing a polyolefin, comprising the steps of:

A. combining a heat-softened unfunctionalized, thermoplastic polyolefin resin with fiber-reinforced thermoset composite particles having a particle size of at most 10 mm and a functionalized thermoplastic polyolefin resin, at a weight ratio of 30 to 90% by weight of the unfunctionalized thermoplastic polyolefin resin, 10 to 60% by weight of the fiber-reinforced thermoset composite particles; and 1 to 50% by weight of the functionalized thermoplastic polyolefin, to form a filled polyolefin resin having the heat-softened thermoplastic polyolefin resin having the fiber-reinforced thermoset composite particles dispersed therein and the functionalized thermoplastic polyolefin dispersed or dissolved therein; and

B. cooling the filled polyolefin resin from step A to solidify the filled polyolefin resin.

The fiber-reinforced thermoset composite contains one or more types of fibers embedded in a matrix of a solid, cured thermoset polymer. The fiber content may be, for example, 1 to 80% of the total weight of the composite, with the cured thermoset polymer constituting, for example, 20 to 99% of the total weight thereof. The fiber content is preferably 25 to 75% by weight and more preferably 40 to 75% by weight.

The fibers may be, for example, vegetable fibers such as jute, hemp, cotton, wool and the like; animal-produced fibers such as silk; ceramic fibers such as glass and other alumino-silicates, boron, mineral wool and the like; metal fibers; polymeric fibers having a melting temperature in excess of 350° C., and carbon fibers. Carbon fibers are a preferred type.

The resin phase or matrix is a cured thermoset polymer, i.e., a polymer that does not have a melting temperature or softening temperature at which it can flow below the temperature at which it thermally degrades. The cured thermoset polymer resin may have a glass transition temperature of at least 100° C. as measured by differential scanning calorimetry.

In some embodiments, the cured thermoset polymer is a cured epoxy resin produced by curing one or more epoxy resins with one or more epoxy hardeners. The epoxy resin may be any among a wide range of resins such as are described, for example, at column 2 line 66 to column 4 line 24 of U.S. Pat. No. 4,734,332, incorporated herein by reference. Aromatic epoxy resins are preferred types. These include, for example, diglycidyl ethers of polyhydric phenol compounds such as resorcinol, catechol, hydroquinone, biphenol, bisphenol A, bisphenol AP (1,1-bis(4-hydroxylphenyl)-1-phenyl ethane), bisphenol F, bisphenol K and tetramethylbiphenol. Examples of epoxy resins of this type include diglycidyl ethers of bisphenol A such as are sold by Olin Corporation under the designations D.E.R.® 330, D.E.R.® 331, D.E.R.® 332, D.E.R.® 383, D.E.R. 661, D.E.R.® 662 and D.E.R.® 667 resins.

Other useful epoxy resins (any of which can be used by themselves or in admixture with one or more others) include, for example, diglycidyl ethers of aliphatic glycols and polyether glycols, such as the diglycidyl ethers of C2-24 alkylene glycols and poly(ethylene oxide) or polypropylene oxide) glycols (including those sold as D.E.R.® 732 and D.E.R.® 736 by Dow Chemical); polyglycidyl ethers of phenol-formaldehyde novolac resins (epoxy novolac resins), including those sold as D.E.N.® 354, D.E.N.® 431, D.E.N.® 438 and D.E.N.® 439 by Dow Chemical; alkyl substituted phenol-formaldehyde resins; phenol-hydroxybenzaldehyde resins; cresol-hydroxybenzaldehyde resins; dicyclopentadiene-phenol resins; cycloaliphatic epoxides including (3,4-epoxycyclohexyl-methyl)-3,4-epoxy-cyclohexane carboxylate, bis-(3,4-epoxycyclohexyl) adipate, vinylcyclohexene monoxide as well as others as described in U.S. Pat. No. 3,686,359; oxazolidone-containing compounds as described in U.S. Pat. No. 5,112,932; dicyclopentadiene-substituted phenol resins; and advanced epoxy-isocyanate copolymers such as those sold commercially as D.E.R. 592 and D.E.R. 6508 (Dow Chemical).

The hardener used to produce the cured epoxy resin may be for example, a polyamine, a polythiol, a carboxylic anhydride, a polyisocyanate or other epoxy hardener.

The cured epoxy resin phase may be impact-modified by, for example, the inclusion of a rubbery phase. The rubbery phase may be, for example, a homopolymer or copolymer of a conjugated diene, a core-shell rubber, or a polyether. The polyether may be incorporated into the cured epoxy resin phase through the inclusion of a reactive polyurethane toughener as described, for example, U.S. Pat. Nos. 5,202,390, 5,278,257, U. S. Published Patent Application No. 2005/0070634, U. S. Published Patent Application No. 2005/0209401, U. S. Published Patent Application 2006/0276601, U.S. Published Patent Application No. 2008/0251202, EP-A-0 308 664, EP-A 1 728 825, EP-A 1 896 517, EP-A 1 916 269, EP-A 1 916 270, EP-A 1 916 272, EP-A-1 916 285, WO 2005/118734 and WO 2012/000171.

In other embodiments, the thermoset polymer is a polyurethane or a cured vinyl ester resin or epoxy vinyl ester resin.

The cured thermoset polymer phase may also contain other ingredients and/or reaction products of other ingredients. These may include, for example, particulate fillers, colorants, catalyst residues, preservatives and the like.

A suitable fiber-reinforced thermoset composite is a cured sheet molding compound (SMC) or bulk molding compound (BMC). The cured material may be, for example; scrap material obtained from trimming or otherwise fabricating parts made from the SMC or BMC (or other composite); rejected parts made from such materials; damaged or worn parts made from such materials, or other post-consumer or reclaimed parts made from such materials.

The fiber-reinforced thermoset composite is formed into particles having a particle size of at most 10 mm, as determined by sieving methods. The preferred particle size is at most 1 mm and more preferably at most 500 μm or at most 250 μm. The particle size may be at least 50 nm, at least 250 nm, at least 1 μm or at least 10 μm.

The particles can be formed by grinding, lathing, pulverizing or other convenient method.

The unfunctionalized thermoplastic polyolefin is a homopolymer or copolymer of at least one alpha-olefin. By “unfunctionalized”, it is meant that the unfunctionalized polyolefin contains less than 0.01 meq/g of functional groups, as described below. The unfunctionalized polyolefin may contain as little as zero meq/g of such functional groups.

The unfunctionalized thermoplastic polyolefin may be a polymer or copolymer of ethylene, particularly one having a density of at least 0.910 g/cm³. Examples of these include low density polyethylene, linear low density polyethylene, high density polyethylene and long chain branched polyethylene polymers and copolymers made, for example, using a metallocene polymerization catalyst.

The unfunctionalized thermoplastic polyolefin preferably is non-elastomeric, i.e., has an elongation to yield of less than 50% as measured according to ASTM D638.

A preferred unfunctionalized thermoplastic polyolefin is a homopolymer of propylene or a copolymer of 50% or more by weight propylene and up to 50% by weight of one or more other alpha-olefins. Among these, polymers of 90 to 100% by weight propylene and up to 10% of one or more other alpha-olefins are useful. An especially preferred unfunctionalized thermoplastic polyolefin is polypropylene.

The polyolefin may be a so-called thermoplastic polyolefin (TPO), which is a mixture of a polyolefin, one or more elastomers and typically one or more fillers.

The functionalized thermoplastic polyolefin is a polyolefin as described above, which contains at least 0.01 milliequivalents of functional groups per gram. It preferably contains at least 0.025 milliequivalents or at least 0.05 milliequivalents of functional groups per gram and may contain, for example, up to 10, up to 5, up to 1, up to 0.5 or up to 0.25 milliequivalents of functional groups per gram.

The functionalized thermoplastic polyolefin may be elastomeric or non-elastomeric. “Elastomeric” for purposes of this invention means the material has an elongation to yield of at least 50% as measured according to ASTM D638.

The functional group is a heteroatom-containing group that is reactive toward epoxy, isocyanate, hydroxyl and/or amino groups. Examples include carboxylic acid anhydride groups (which may be cyclic), carboxyl groups, hydroxyl groups, primary or secondary amine groups, imide groups (which may be cyclic), thiol groups and isocyanate groups.

In some embodiments, the functionalized thermoplastic polyolefin is a maleic anhydride-grafted polyolefin that contains pendant functional groups having the structure:

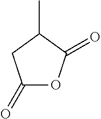

Maleic anhydride-grafted polyolefins are available commercially. A suitable maleic-anhydride-grafted polypropylene is available from Exxon as Exxelor 1015. A suitable maleic anhydride-grafted ethylene-octene copolymer elastomer is available from The Dow Chemical Company as Amplify™ GR216.

In some embodiments, the functional group is a maleic anhydride-grafted polyolefin in which the pendant cyclic anhydride groups have been further reacted to produce an N-substituted maleimide group such as an N-hydroxyalkyl imido or N-aminoalkyl imido group. Such an N-substituted maleimide group may have the structure:

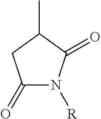

wherein R is hydroxyl- or primary or secondary amino-substituted alkyl group. R may be, for example, —(CH₂)ₙ—OH, where n is 1 to 8; —[(CH₂)ₙ—CH(OH)]—(CH₂)ₘH where n and m are independently 1 to 8 and m is 1 to 8; or —(CH₂)ₙ—NH—(CH₂)ₘ—H in which n and m are independently 1 to 8.

The filled polyolefin of the invention contains 30 to 90% by weight of the unfunctionalized thermoplastic polyolefin resin, 10 to 60% by weight of the fiber-reinforced thermoset composite particles, and 1 to 50% by weight of the functionalized thermoplastic polyolefin resin, based on the combined weights of these three components.

The unfunctionalized thermoplastic polyolefin resin in some embodiments constitutes at least 40%, at least 50% or at least 60% of the combined weight of components a)-c), and may in some embodiments may constitute up to 80% or up to 70% thereof.

The fiber-reinforced thermoset composite particles in some embodiments constitute at least 20% or at least 25% of the combined weight of components a)-c), and in some embodiments may constitute up to 50% or up to 40% thereof.

The functionalized thermoplastic polyolefin resin in some embodiments constitute at least 3% or at least 5% of the combined weight of components a)-c), and may in some embodiments may constitute up to 30%, up to 20% or up to 15% thereof.

In some embodiments, the filled polyolefin contains 5 to 40%, especially 10 to 30%, of fibers provided by the fiber-reinforced thermoset composite particles.

The filled polyolefin is conveniently produced by heat-softening the unfunctionalized thermoplastic polyolefin and combining the other ingredients into the heat-softened unfunctionalized thermoplastic polyolefin. The functionalized thermoplastic may or may not be similarly heat-softened but preferably is. The fiber-reinforced thermoset composite is combined with the other materials in the form of solid particles due to the thermoset nature of the cured thermoset resin phase.

The unfunctionalized thermoplastic polyolefin is conveniently heat-softened by heating to a temperature above its crystalline melting temperature (if a semi-crystalline material) or above its Vicat softening temperature (ASTM D1525) if it is non-crystalline. A preferred temperature is at least 150° C. or at least 180° C. The temperature may be any higher temperature below that at which the polymer degrades, such as up to 320° C., up to 300° C., up to 280° C. or up to 250° C.

The combining step is conveniently performed in extrusion equipment such as a single- or twin-screw extruder. In such an extrusion process, the unfunctionalized thermoplastic polyolefin can be fed into the inlet end of the extruder in the form of solid particles and heat-softened in the extruder. The fiber-reinforced epoxy particles are conveniently added to the heat-softened unfunctionalized polyolefin into a downstream section of the extruder and mixed in. The functionalized thermoplastic polyolefin can be introduced before, simultaneously with or after any of the other materials.

After the materials are combined, they are cooled to solidify the heat-softened components.

In the filled polyolefin, the fiber-reinforced thermoset composite particles are dispersed in the unfunctionalized thermoplastic polyolefin. The unfunctionalized thermoplastic polyolefin is dispersed or dissolved in the functionalized thermoplastic resin. It may be partially dispersed and partially dissolved therein.

The presence of the functionalized thermoplastic resin has been found to improve the efficacy of the fiber-reinforced epoxy composite particles.

In embodiments in which both the unfunctionalized and functionalized thermoplastic polyolefins are non-elastomeric, the presence of both the functionalized polyolefin and particles in the composition leads to a large increase in tensile strength and tensile modulus, compared to the case in which only the particles and unfunctionalized thermoplastic polyolefin are present. The tensile strength and tensile modulus are significantly greater than those of the unfunctionalized thermoplastic polyolefin resin by itself.

In some embodiments, the functionalized thermoplastic polyolefin is elastomeric whereas the unfunctionalized thermoplastic polyolefin is not. In such embodiments, the presence of the elastomeric material tends to reduce the tensile strength and elongation of the filled polyolefin, somewhat offsetting the increase in those properties due to the presence of the fiber-reinforced thermoset composite particles. However, the impact strength often is increased in such embodiments. Such embodiments represent a means by which higher impact strengths can be obtained while maintaining or even increasing tensile strength and modulus.

The filled polyolefin may contain other ingredients in addition to components a)-c). These may include, for example, additional particulate reinforcing agents such as mineral fillers and the like; additional reinforcing fibers such as those mentioned above with regard to the fiber-reinforced thermoset composite; various lubricants and other processing aids; colorants; antioxidants; biocides; diluents; one or more other thermoplastics; one or more impact modifiers; and the like.

The filled polyolefin is a useful structural thermoplastic material. It is useful, for example, in making housings for durable goods such as refrigerators, freezers and other large appliances; into automotive and other vehicular body parts; tubes and pipes; various injection-molded parts and the like.

The following examples are provided to illustrate the invention but are not intended to limit the scope thereof. All parts and percentages are by weight unless otherwise indicated.

### EXAMPLES 1-4 AND COMPARATIVE SAMPLES A-C

A fiber-reinforced epoxy composite made by compression molding a commercially available sheet molding compound is chopped into particles having a size of less than 10 mm. The starting composite and resulting particles contain 33% by weight cured epoxy resin and 67% by weight carbon fibers.

Filled polyolefin Examples 1-4 and Comparative Sample A are made by combining an injection molding grade, 5 melt index unfunctionalized polypropylene resin and a functionalized polyolefin additive as indicated in Table 1 in a Haake mixer operated at 200° C. and 50 rpm. Once the polypropylene and additive have melted, the foregoing fiber-reinforced epoxy composite particles are added slowly under the same conditions and mixed into the molten materials for 5 minutes.

Comparative Samples B and C are commercially available glass-filled polypropylene samples containing 30% and 40% by weight, respectively, of long glass fibers. These are sold by Ticona Engineering Polymers as Celestran™ PP-GF30-02 and Celestran PP-GF40-02.

TABLE 1

| | Parts By Weight | | | | |
|---|---|---|---|---|---|
| | | | | | Comp. |
| Ingredient | Ex. 1 | Ex. 2 | Ex. 3 | Ex. 4 | A* |
| Polypro- | 60 | 60 | 60 | 60 | 70 |
| pylene | | | | | |
| Composite | 30 | 30 | 30 | 30 | 30 |
| Particles¹ | | | | | |
| Additive | 10 | 10 | 10 | 10 | 0 |
| Amount | | | | | |
| Additive | MAH- | Amine- | MAH- | Amine- | None |
| Type | func- | func- | func- | func- | |
| | tional | tional | tional | tional | |
| | PP² | PP³ | PE elas- | PE elas- | |
| | | | tomer⁴ | tomer⁵ | |
| % Carbon | 20 | 20 | 20 | 20 | 20 |
| Fiber | | | | | |

*Comparative.
¹Particles of the chopped fiber-reinforced epoxy composite.
²A polypropylene copolymer modified with 0.25-0.5 wt.-% maleic anhydride (based on weight of the copolymer), having a density of 0.900 g/m3, melt flow index (190 °C., 2.16 kg) of 22 g/10 minutes, and a peak melting temperature of about 147 °C.
³An amine-functional polypropylene copolymer made by reacting the MAH-functional polypropylene copolymer described in note 2 with diethylene diamine to produce N-substituted maleic imide groups in which the substituent contains a secondary amino group.
⁴An ethylene/n-octene copolymer elastomer having a density of 0.87 g/cm3 and a melt flow index of 0.5 g/10 min (190 °C./2.16 kg), grafted with maleic anhydride.
⁵An amine-functional ethylene/n-octene copolymer made by reacting a diamine with the MAH-functional PE elastomer of note 4, to produce N-substituted maleic imide groups in which the substituent contains a secondary amino group.

Specimens for tensile testing are made from each of Examples 1-4 and Comparative Samples A-C. In each case, the blends are compression molded at 200° C. for 5 minutes to form 1 mm sheets. Tensile strength at break, tensile modulus and elongation at break are measured in each case according to ASTM D638, using a 10 inch (25.4 cm) specimen, a 5 inch (12.7 cm) gauge length, hydraulic grips with a grip strength of about 2200 pounds (9800 N) and a 5 mm/minute head speed. Results are as indicated in Table 2.

TABLE 2

| | Tensile | | Tensile |
|---|---|---|---|
| Sample | Strength | Elongation | Modulus |
| Designation | (MPa) | (%) | (GPa) |
| 1 | 50 | 1.65 | 4.65 |
| 2 | 43 | 1.3 | 4.45 |
| 3 | 22 | 1.05 | 3.1 |
| 4 | 22 | 1.15 | 3.0 |
| A* | 19 | 0.8 | 3.2 |
| B* | 19 | 0.75 | 2.8 |
| C* | 18 | 0.85 | 3.0 |

*Comparative

Comparative Sample A illustrates the effect of combining the particulate fiber-reinforced epoxy composite particles into polypropylene without the benefit of the functionalized polyolefin additive. Tensile strength, elongation and tensile modulus each are only similar to what is obtained with a glass-reinforced polypropylene (Comparative Samples B and C) despite the presence of stronger carbon fibers in place of the glass fibers of Comparative Samples B and C.

Examples 1 and 2 of the invention exhibit more than a doubling of tensile strength and nearly a 50% increase in tensile modulus, compared to Comparative Sample A, while simultaneously exhibiting an elongation increase of 50 to 100%. These examples demonstrate the strongly beneficial effect of the functionalized polypropylene additive.

Examples 3 and 4 show the effect of using a functionalized ethylene-octene copolymer as the additive. In these cases, tensile strength increases by about 15% over the control. This is surprising because of the elastomeric nature of the ethylene-octene copolymer. Ethylene-octene elastomers of this type are rubbery materials that are used as impact modifiers for polypropylene. As such, their inclusion would be expected to result in a decrease in tensile strength and in tensile modulus. Instead, tensile modulus is preserved and an increase in tensile strength is seen, while also obtaining an increase in impact strength. Examples 3 and 4 represent an approach to increasing the impact strength of polypropylene while preserving or even improving tensile properties.

1. A filled polyolefin comprising:
a) 30 to 90% by weight, based on the total weight of components a)-c), of an unfunctionalized polyolefin resin, the unfunctionalized polyolefin resin having dispersed therein;
b) 10 to 60% by weight, based on the total weight of components a)-c), of a particulate fiber-reinforced thermoset composite, the particulate having a maximum particle size of 10 mm; and
c) 1 to 50% by weight, based on the total weight of components a)-c), of a functionalized polyolefin.

2. The filled polyolefin of claim 1, wherein the unfunctionalized polyolefin resin is an unfunctionalized polypropylene.

3. The filled polyolefin of claim 1 wherein the functionalized polyolefin contains functional groups selected from carboxylic acid anhydride, imido, amino and hydroxyl groups, or a mixture of two or more thereof.

4. The filled polyolefin of claim 1 wherein the functionalized polyolefin contains functional groups selected from carboxylic acid anhydride, cyclic imido, N-hydroxyalkyl imido or N-aminoalkyl imido groups, or a mixture of two or more thereof.

5. The filled polyolefin of claim 1 wherein the functionalized polyolefin is a functionalized polypropylene.

6. The filled polyolefin of claim 1 wherein the functionalized polyolefin is a functionalized ethylene-alpha-olefin elastomer.

7. The filled polyolefin of claim 1 which contains 30 to 75% component a), 10 to 50% component b) and 5 to 20% of component c).

8. The filled polyolefin of claim 1 wherein the fiber-reinforced thermoset composite is a fiber-reinforced epoxy composite.

9. A method for recycling a fiber-reinforced thermoset composite, comprising the steps of:
I. forming the fiber-reinforced thermoset composite into particles having a particle size of at most 10 mm;
II. combining the particles from step I with a heat-softened unfunctionalized polyolefin resin and a functionalized polyolefin resin at a weight ratio of 30 to 90% by weight of the unfunctionalized polyolefin resin, 10 to 60% by weight of the particles; and 1 to 50% by weight of the functionalized polyolefin resin, to form a filled polyolefin resin comprising the heat-softened unfunctionalized polyolefin resin having the particles dispersed therein and the functionalized polyolefin resin dispersed or dissolved therein; and
III. cooling the filled polyolefin resin from step II to solidify the filled polyolefin resin.

10. The method of claim 9 wherein the fiber-reinforced thermoset composite is a fiber-reinforced epoxy composite.

11. A method for reinforcing a polyolefin, comprising the steps of:
A. combining a heat-softened unfunctionalized polyolefin resin with fiber-reinforced thermoset composite particles having a particle size of at most 10 mm and a functionalized polyolefin resin, at a weight ratio of 30 to 90% by weight of the unfunctionalized polyolefin resin, 10 to 60% by weight of the fiber-reinforced thermoset composite particles; and 1 to 50% by weight of the functionalized polyolefin, to form a filled polyolefin resin having the heat-softened polyolefin resin having the fiber-reinforced thermoset composite particles dispersed therein and the functionalized polyolefin dispersed or dissolved therein; and
B. cooling the filled polyolefin resin from step A to solidify the filled polyolefin resin.

12. The method of claim 11 wherein the fiber-reinforced thermoset composite is a fiber-reinforced epoxy composite.
